(19) United States
(12) Patent Application Publication
(10) Pub. No.: US 2015/0143932 A1
(43) Pub. Date: May 28, 2015

(54) GYROSCOPIC SYSTEMS TO STABILIZE VEHICLES AND RECYCLE KINETIC ENERGY

(71) Applicant: Clyde Igarashi, Honolulu, HI (US)

(72) Inventor: Clyde Igarashi, Honolulu, HI (US)

(73) Assignee: Thrustcycle Enterprises LLC, Honolulu, HI (US)

(21) Appl. No.: 14/093,023

(22) Filed: Nov. 28, 2013

(51) Int. Cl. B62D 37/06

(52) U.S. Cl. CPC B62D 37/06
USPC 74/5.4

(57) ABSTRACT

Gyroscopic systems to stabilize vehicles and provide kinetic energy recovery are disclosed. The gyroscopic system uses gyroscopic forces to maintain a vertical orientation at zero and low speeds, as well as maintain stability at all speeds. The gyroscopic forces are also be used to affect the bank angle of vehicles in turns, and to improve cornering by shifting forces to the inside wheels. The gyroscopes are also used to store kinetic energy, which is later used to accelerate the vehicle.

### CROSS-REFERENCE TO RELATED APPLICATIONS

This application claims priority to and the benefit of U.S. Provisional Patent Application Ser. No. 61/730,850 filed on Nov. 28, 2012 by David Allan Ryker and Clyde Igarashi, entitled Gyroscopic Systems to Stabilize Vehicles and Recycle Kinetic Energy; and U.S. Provisional Patent Application Ser. No. 61/891,907, filed on Oct. 17, 2013 by David Allan Ryker and Clyde Igarashi, entitled Manual and Automatic Gyroscopic Systems to Stabilize Vehicles and Recycle Kinetic Energy, each of which are hereby incorporated herein by reference in their entirety.

### BACKGROUND OF THE INVENTION

1. Field of the Invention

The present invention is generally in the field of kinetic energy recovery systems. More specifically, the present invention teaches a kinetic energy recovery system that stabilizes vehicles using gyroscopic forces to maintain a vertical orientation at zero and low speeds, as well as maintain stability at all speeds.

2. Background Art

Vehicles with in-line wheels are inherently unstable and prone to falling over if the wheels slip or are otherwise thrown off balance. They also tend to fall over at zero speed or very low speed without the use of kickstands or side support wheels. Vehicles with more than two wheels often have problems with under steering, and over steering.

Current means of enhancing stability of vehicles are limited to the use of side support wheels or skids, which inhibits handling and maneuverability. Furthermore, they do not provide a means to recover kinetic energy lost during braking, and instead decrease efficiency. Current means of controlling gyroscopes are not effective enough to use on land, water, air or other forms of transportation to maintain a vertical orientation or to correct over-steering or under-steering.

The present invention uses gyroscopic forces to maintain a vertical orientation at zero and low speeds, as well as maintain stability at all speeds. The gyroscopic forces are also be used to affect the bank angle of vehicles in turns, and to improve cornering by shifting forces to the inside wheels. The gyroscopes are also used to store kinetic energy, which is later used in acceleration.

Currently gyroscopes are used primarily by the military, NASA and marine industry in many different applications but very little in the transportation industry or in the public marketplace. This invention will provide a simple means of controlling precession and correcting drift, either by the use of a manually controlled gyroscopic system, or by the use of an automatic gyro-stabilizing system. The systems can be used in many transportation vehicles including off-road, marine, air cushion and aircraft. By the use of the flywheel energy return system of the present invention within the manual or automatic systems, kinetic energy can stored in the spinning mass and reused to accelerate the vehicle, whereas other stabilizing system provide no such capabilities.

### SUMMARY OF THE INVENTION

The present invention is directed to vehicles with in-line wheels that are inherently unstable and prone to falling over if the wheels slip or are otherwise thrown off balance. These vehicles also tend to fall over at zero speed or very low speed without the use of kickstands or side support wheels. Vehicles with more than two wheels often have problems with under-steering, and/or over-steering. The invention claimed here solves these problems.

The gyroscopic systems of the present invention can be used to maintain stability in vehicles either automatically or manually with driver input. The systems will harness gyroscopic forces to maintain stability, control bank angle in turns, and improve under-steer and over-steer problems in vehicles with two wheels or more. The gyroscopes are also used to store kinetic energy, which is later used in acceleration.

The claimed invention differs from what currently exists. The gyroscopic control systems of the present invention enables the use of gyroscopic forces to maintain stability at all speeds, including zero speed which would allow two wheeled vehicles to be enclosed. Thus, aerodynamic efficiency is improved, and passengers can be protected from the elements. Furthermore, the system improves handling and maneuverability by harnessing gyroscopic forces during turning and banking, thereby correcting problems with under-steering and/or over-steering. Vehicles with three or more wheels will also benefit, as gyroscopic forces are harnessed to affect the bank angle in turns, and improve cornering by shifting forces to the inside wheels.

The present invention is an improvement on what currently exists. The gyroscopic control system of the present invention enables the use of gyroscopic forces to maintain stability at all speeds, including zero speed which would allow two wheeled vehicles to be enclosed. Thus, aerodynamic efficiency can be improved, and passengers can be protected from the elements. Furthermore, the system improves handling and maneuverability by harnessing gyroscopic forces during turning and banking, thereby correcting problems with under steering and over steering. Vehicle with three or more wheels would also benefit, as gyroscopic forces are harnessed to affect the bank angle in turns, and improve cornering by shifting forces to the inside wheels. In addition, the gyroscopic stability and control systems of the present invention provide a means to store kinetic energy that would otherwise be wasted during the braking process, and re-uses it to accelerate vehicles.

The use of side support wheels inhibits handling and maneuverability and do not provide additional stability or control when they are not engaged. The use of support wheels does not provide any method of kinetic energy recovery, as with the gyro systems of the present invention. The use of three or more wheels on land vehicles typically results in under-steering and/or over-steering problems.

The system of the present invention uses gyroscopic forces to maintain a vertical orientation at zero and low speeds, as well as maintain stability at all speeds. The gyroscopic forces are also be used to affect the bank angle of vehicles in turns, and to improve cornering by shifting forces to the inside wheels. The gyroscopes are also used to store kinetic energy, which is later used in acceleration.

### BRIEF DESCRIPTION OF THE DRAWINGS

FIG. 1 illustrates a view of a Flat Disk Flywheel with bolt-on hubs in accordance with one embodiment of the present invention.

FIG. 2 illustrates a view of a Tapered Flywheel in accordance with one embodiment of the present invention.

FIG. 3 illustrates an expanded view of a Flat Disk Flywheel in accordance with one embodiment of the present invention.

FIG. 4 illustrates a view of a Tapered Flywheel illustrating an un-penetrated core in accordance with one embodiment of the present invention.

FIG. 5 illustrates a view of a Multi-Disk Flywheel bolted together with a staggered bolting pattern so that bolt holes don't line up and there is no hole in the center.

FIG. 6 illustrates a view of a totally self-contained rotating battery flywheel unit in accordance with one embodiment of the present invention.

FIG. 7 illustrates a breakdown view of a self-contained rotating battery flywheel in accordance with one embodiment of the present invention.

FIG. 8 illustrates a breakdown view of a case for self-contained rotating battery in accordance with one embodiment of the present invention.

FIG. 9 illustrates a breakdown view of a completely assembled outer case with motors bolted and brush holders in place in accordance with one embodiment of the present invention.

FIG. 10 illustrates an Enlarged Diagram of a Slip Ring in accordance with one embodiment of the present invention.

FIG. 11 illustrates a Self-Contained Rotating Battery Flywheel System in accordance with one embodiment of the present invention.

FIG. 12 illustrates a Hollow Battery Flywheel Combination Connected Directly to a Counter Rotating Disk Flywheel in accordance with one embodiment of the present invention.

FIG. 13 illustrates a Hollow Battery Flywheel Combination Connected Directly to a Counter Rotating Disk Flywheel With a Planetary Gear and Clutch that Separates the Mechanical from the Contained System Flywheel in accordance with one embodiment of the present invention.

FIG. 14 illustrates a Connected Self-Contained Counter Rotating Flywheel Combination in a Case in accordance with one embodiment of the present invention.

FIG. 15 illustrates a Hollow Flywheel with Solid Center Core and the Motor/Generators on Each Side within the Contained Battery Flywheel System in accordance with one embodiment of the present invention.

FIG. 16 illustrates a Breakdown View of the Components of the Hollow Flywheel Battery Combination Showing the Epoxy-Filled Outer Hub and the Battery Connection in accordance with one embodiment of the present invention.

FIG. 17 illustrates a Hollow Flywheel Battery Combination Rotating Inside of a Mechanical Flywheel Enclosure That is Counter Rotating By Use of an Internal 1:1 Planetary Gearbox in accordance with one embodiment of the present invention.

FIG. 18 illustrates a Rotating Enclosed Battery Combination With Two Motors in accordance with one embodiment of the present invention.

FIG. 19 illustrates a Hybrid Drive System for DC to AC Conversion Using Multiple Counter-Rotating Flywheels in accordance with one embodiment of the present invention.

FIG. 20 illustrates a Manually Controlled Gyro System Linked to the Steered Wheel by Sectored Gears on Top and Bottom and Side View of a Single Gyro System in accordance with one embodiment of the present invention.

FIG. 21 illustrates a Manually Controlled Tandem Double Gyro System, Linked Using Center Sectored Gears in accordance with one embodiment of the present invention.

FIG. 22 illustrates a Positioning Torquing Arms Which Also Function as Landing Gear with Wheels in accordance with one embodiment of the present invention.

FIG. 23 illustrates an In-line Dual Gyro Steering with Direct Gearing in accordance with one embodiment of the present invention.

FIG. 24 illustrates a Top View of Direct Gearing to Connect the Linked Gyroscopes and Steered Wheel to a Steering Apparatus in accordance with one embodiment of the present invention.

FIG. 25 illustrates a Gyro Steered and Manually Torqued Rear-Wheel Steered Recumbent in accordance with one embodiment of the present invention.

FIG. 26 illustrates an Expanded View of the Side Torque Arms Which Also Function as Landing Gears in accordance with one embodiment of the present invention.

FIG. 27 illustrates a Gyro Steered Recumbent in accordance with one embodiment of the present invention.

FIG. 28 illustrates a Dual Side-by-Side Sector Geared Gyro System Using Belt or Chain Drive Gear Reduction with Connection to the Steered Wheel as Well as to Handlebar Steering in accordance with one embodiment of the present invention.

FIG. 29 illustrates a Stacked Gear Connected Dual Gyro Steered System in accordance with one embodiment of the present invention.

FIG. 30 illustrates a Side View of Automatic In-line Two Gyro Control System Using Center Mounted Sectored Gears in accordance with one embodiment of the present invention.

FIG. 31 illustrates a Side View of a Single Gyroscope Control System in accordance with one embodiment of the present invention.

FIG. 32 illustrates a Front View of Single Gyroscope Unit with Two Motor/Generators Attached in accordance with one embodiment of the present invention.

FIG. 33 illustrates a Top View of Side-by-Side Counter-Rotating Gyros Linked by Sectored Gears in accordance with one embodiment of the present invention.

FIG. 34 illustrates a Staggered Counter-Rotating Gyros Linked Using Sectored Gears in accordance with one embodiment of the present invention.

FIG. 35 illustrates a Top View of Side-by-Side Counter-Rotating Gyroscopes Linked Using Beveled Gears in accordance with one embodiment of the present invention.

FIG. 36 illustrates Staggered Gyroscopes Linked Using a Bell Crank and Low Friction Bearings, Precession Controlled Using Torquing Wheel and Induction Coil on a Primary Gimbal in accordance with one embodiment of the present invention.

FIG. 37 illustrates a Top view of Torquing Wheel or Ring with Two Induction Coils in accordance with one embodiment of the present invention.

FIG. 38 illustrates a Side View of Gyro Caging Device with Disk Brake and Brake Caliper on a Primary Gimbal in accordance with one embodiment of the present invention.

FIG. 39 illustrates a Front View of Gyroscopic Drift Control with Secondary Gimbal Offset Below Center and a Linear Motor Connected Above the Pivot Point in a Two Gyro System in accordance with one embodiment of the present invention.

FIG. 40 illustrates a Three Position Front View of Drift Control System with Secondary Gimbal Offset Below Center in accordance with one embodiment of the present invention.

FIG. 41 illustrates a Weighted Swinging Pendulum Device and Micro Switches in accordance with one embodiment of the present invention.

FIG. 42 illustrates a Front View of Drift Control System with Pendulum Attached, Secondary Gimbal Offset Above Center with the Linear Motor Connected Below the Pivot Point in accordance with one embodiment of the present invention.

FIG. 43 illustrates a Drift Control System with Pendulum Switch Activated in Turn in accordance with one embodiment of the present invention.

FIG. 44 illustrates a Landing Gear System in accordance with one embodiment of the present invention.

FIG. 45 illustrates a Side View of Inner Working of the Trailer with Swing-Arm and Staggered Counter-Rotating Vertical Gyroscopes in accordance with one embodiment of the present invention.

FIG. 46 illustrates a Two In-Line Wheels Hybrid Module for Two Power Sources in accordance with one embodiment of the present invention.

FIG. 47 illustrates a Trailer with Hover Pad Instead of Wheel(s) in accordance with one embodiment of the present invention.

FIG. 48 illustrates a Trailer with Weight-Support Wheel and Trap-Door Landing Gear Deployed with Outline of Batteries, Rear Connection Point and Gyroscope in accordance with one embodiment of the present invention.

### DETAILED DESCRIPTION OF THE INVENTION

The present invention pertains to a mobile kinetic energy recovery system featuring gyroscopically mounted flywheels that ensures highly efficient energy storage and mechanical stability throughout the velocity ranges of operation of the system. The following description contains specific information pertaining to various embodiments and implementations of the invention. Furthermore, the present specification need not represent some of the specific details of the present invention in order to not obscure the invention. A person of ordinary skill in the art would have knowledge of such specific details not described in the present specification. Others may omit or only partially implement some features of the present invention and remain well within the scope and spirit of the present invention.

The following drawings and their accompanying detailed description apply as merely exemplary and not restrictive embodiments of the invention. To maintain brevity, the present specification has not exhaustively described all other embodiments of the invention that use the principles of the present invention and has not exhaustively illustrated all other embodiments in the present drawings.

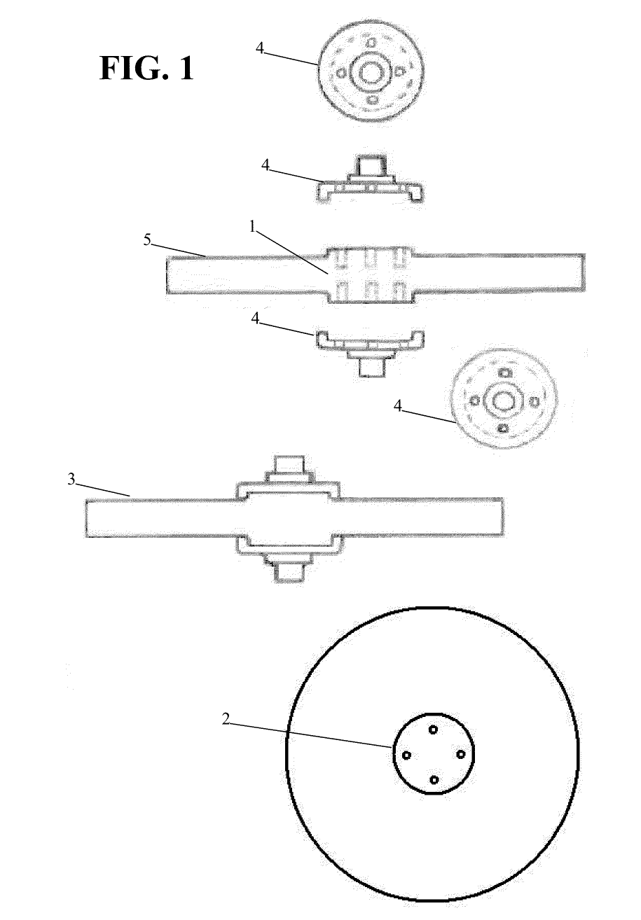

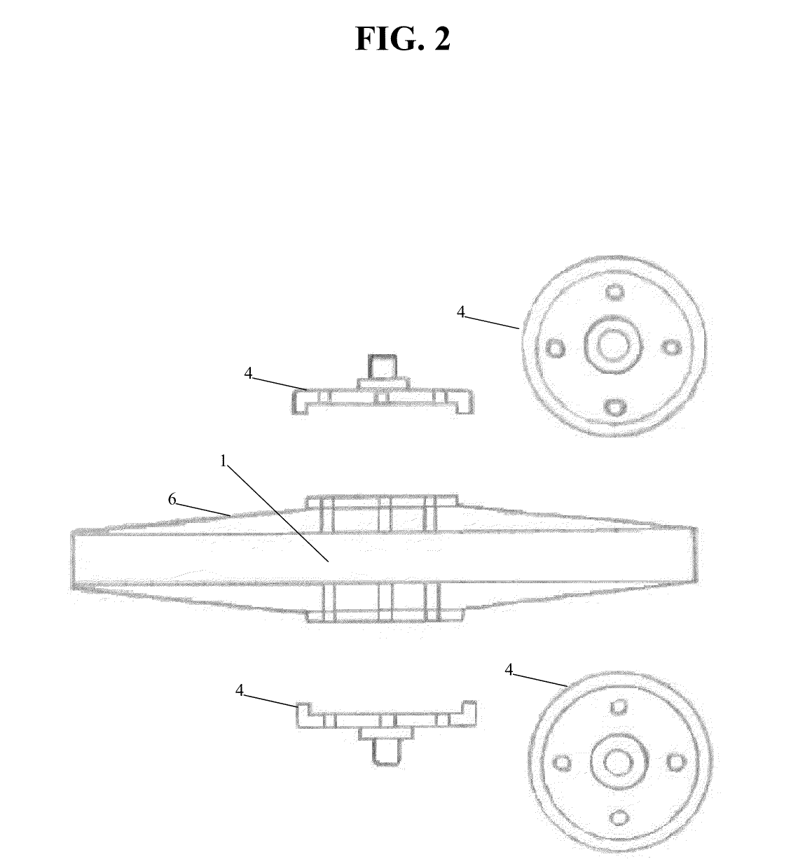

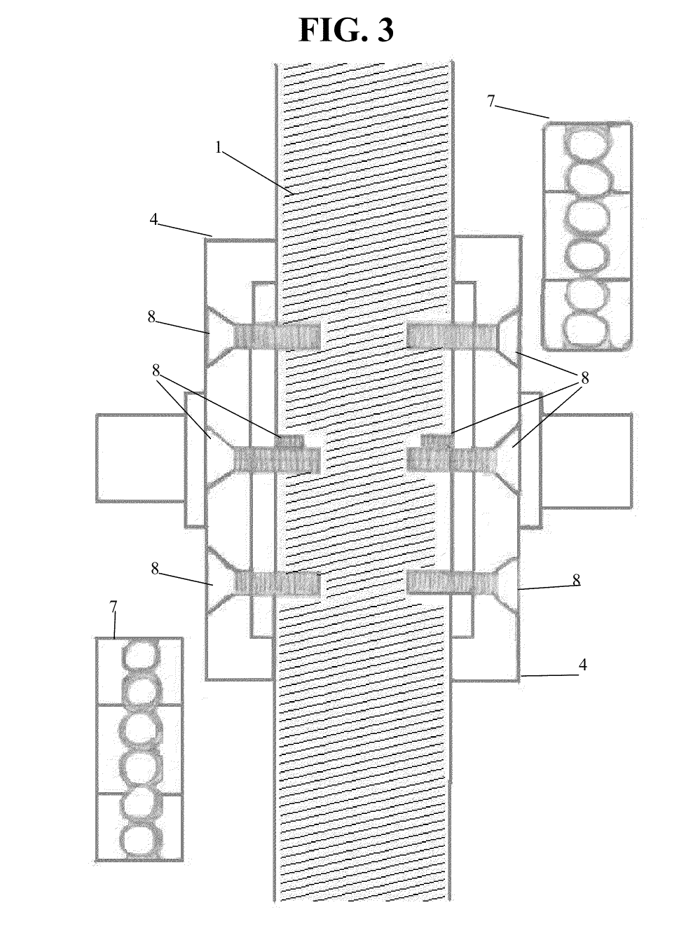

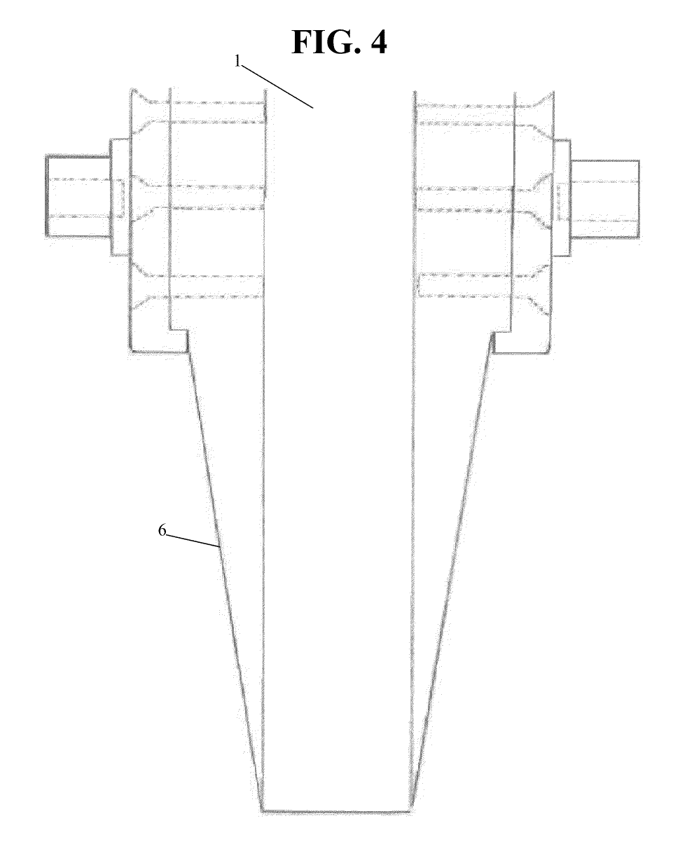

FIGS. 1 through 4 illustrate stronger designs for flywheels used in gyroscopic and kinetic energy recovery systems. FIG. 1 depicts a flat disk flywheel with bolt-on hubs. A flat disk flywheel 2 machined from steel or any high strength material with a raised center for mounting and positioning bolt-on hubs as such: a flywheel 3 with hubs bolted in place; bolt-on machined hubs 4; side view of flywheel 5 with dotted lines indicating the bolts penetrate the mass of the flywheel but do not pass all the way through, leaving an un-penetrated center core 1. Bolts that do penetrate the flywheel all the way through could be used, but they should not penetrate the center of the flywheel. FIG. 2 is an example of a tapered flywheel 6 indicating bolts only penetrate the flywheel half way on each side while maintaining an un-penetrated core 1. FIG. 3 expanded view of the flywheel from FIG. 1 with metal shielded sealed low friction bearings 7. and bolts 8. FIG. 4 shows tapered flywheel 6 illustrating the un-penetrated core 1.

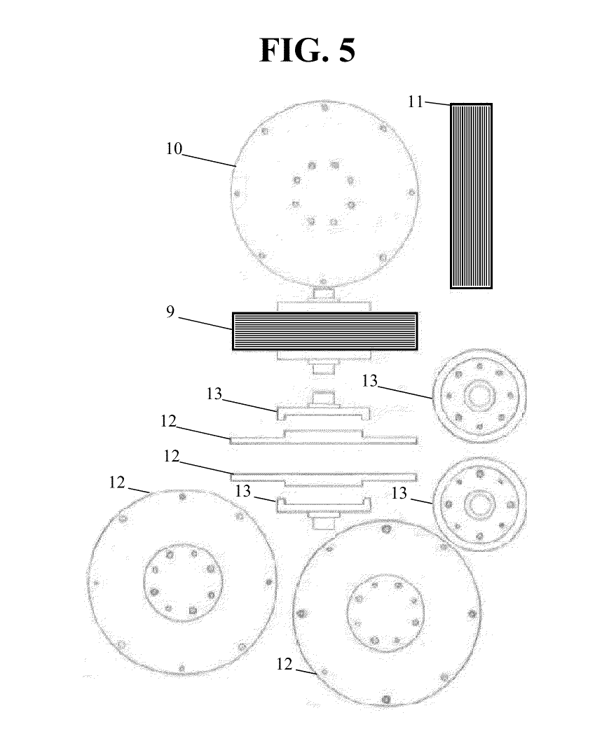

FIG. 5 shows a multi-disk flywheel completely bolted together multi-disk flywheel 9. A single laser-cut disk 10 with staggered bolt holes 11. By changing the length of the bolts and varying the number of disks 9, any desired thickness and weight may be achieved. Supporting outer disks 12 are shown with raised center hubs of varying thickness depending on the size of the flywheel. Bolt-on hubs 13 with recessed bolt holes are also shown. This embodiment provides a practical and inexpensive method of building a flywheel. It is easy to assemble and if there is a problem with a disk, it can be easily disassembled and the disk can be replaced at minimal cost.

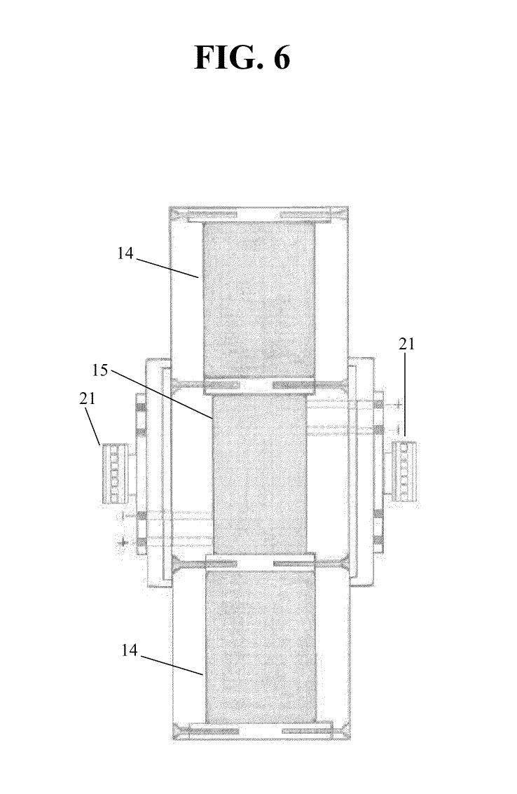

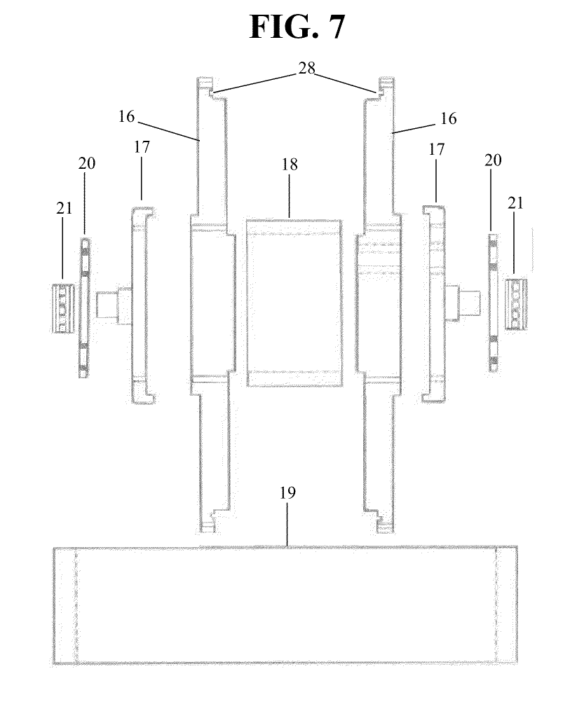

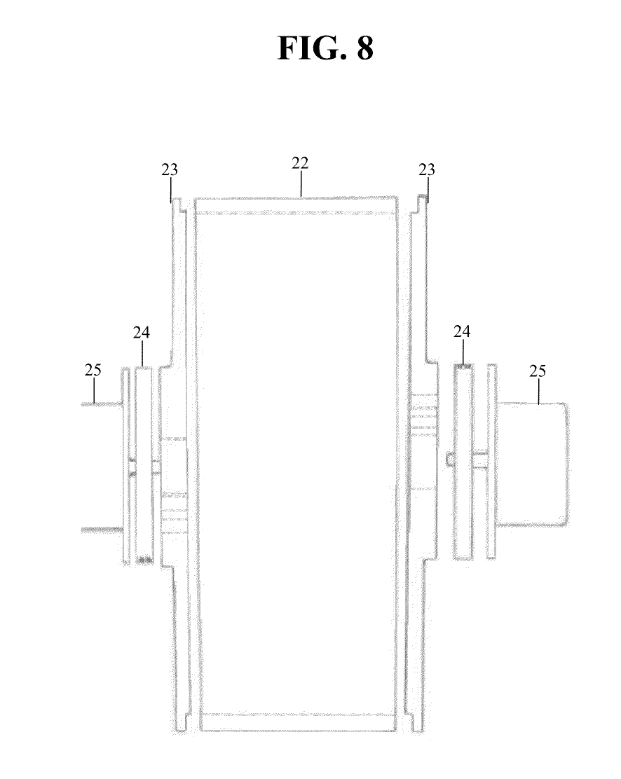

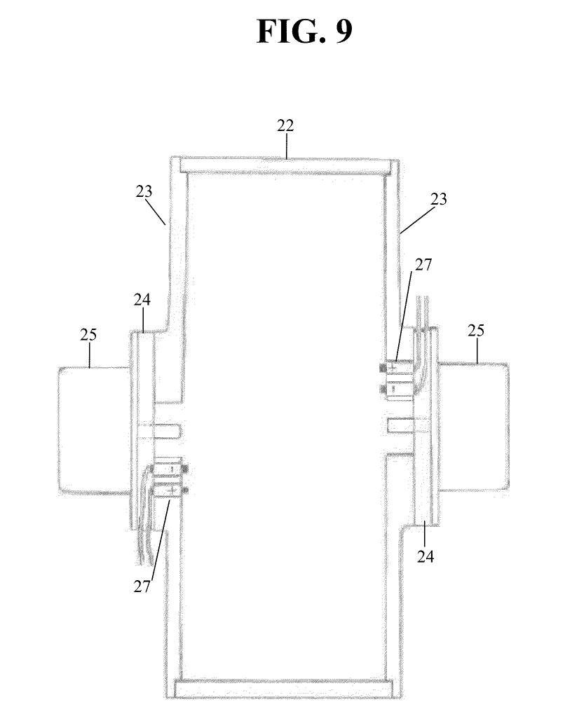

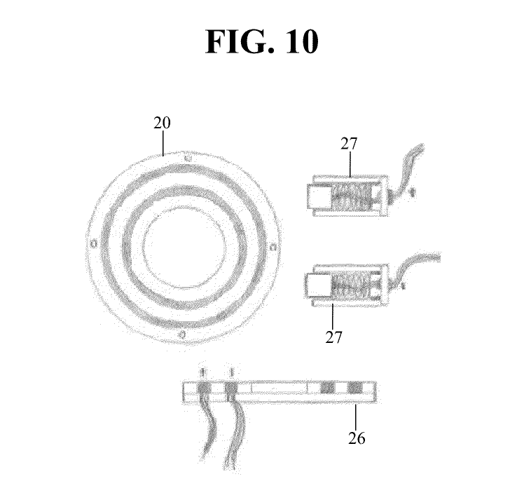

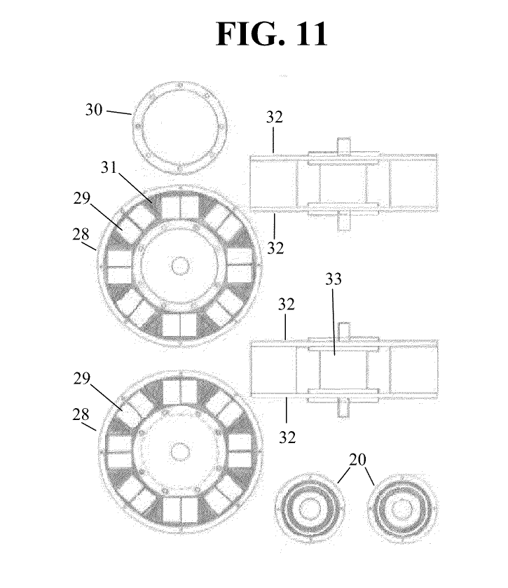

FIGS. 6 through 11 illustrate self-contained flywheels with the batteries, electronics and motors in vacuumed or partially vacuumed cases, using slip rings to transfer energy from the rotating mass. FIG. 6 illustrates a totally self-contained rotating battery flywheel. The outer shaded areas 14 indicate a chemical battery or any sealed battery chemistry and/or capacitors in the outer rim in order to use the normally static weight of a battery pack as a source of kinetic energy. Alternatively, a chemical or any sealed battery chemistry and/or capacitor design could be placed in the inner rim or throughout the flywheel. The unfilled area is filled with epoxy resin or any number of binding compounds or elements that are commonly known in the field, to bind and strengthen the enclosed compliment of batteries or any specific battery chemistry (including aluminum air, zinc air, lithium air, nickel-zinc, vanadium, or any known or unknown battery combination as well as any type of capacitor construction). The center shaded area 15 is used for the electronics as needed: battery management system modules (BMS), controllers and any other electronics that may be needed for applicable battery chemistries. FIG. 7 is a breakdown of FIG. 6 self contained rotating battery flywheel, showing the Case sides 16, bolt-on hubs 17, inner case tube 18, outer case tube 19 that is bolted to the recessed area of the case sides, electric slip rings 20, outer bearings 21, cut-out 28 for O-ring seal. FIG. 8 shows the breakdown of case including the outer case 22, case sides 23, spacers 24 for wires to pass through, and motor (DC, AC, hydraulic, or any other motor/generator combination) 25. FIG. 9 illustrates a completely assembled outer case with motors 25 bolted and brush holders 27 in place. FIG. 10 depicts an enlarged diagram of the slip ring 20, plastic backing plate 26, screw-in brush holders 27. FIG. 11 is a self-contained rotating battery flywheel system. With tubular outer case cover 28, encased chemical batteries or cells 29, tubular inner case 30 and epoxy resin filling 31 or any other binding compounds known in the field, disk side plates 32. DC motor/generator 33, either double axle or two separated motors with single axles that bolt to the inner case and slip rings 20.

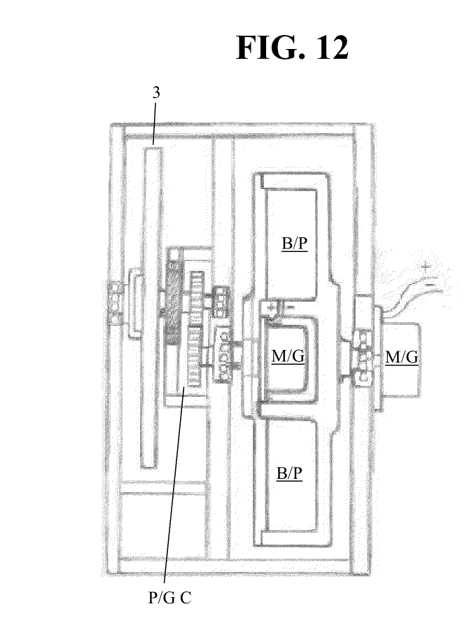

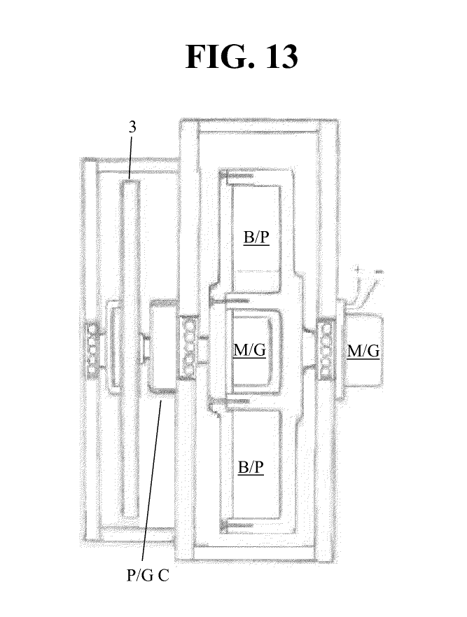

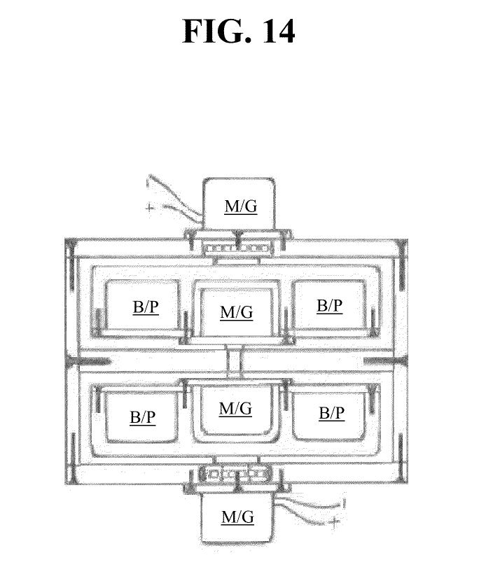

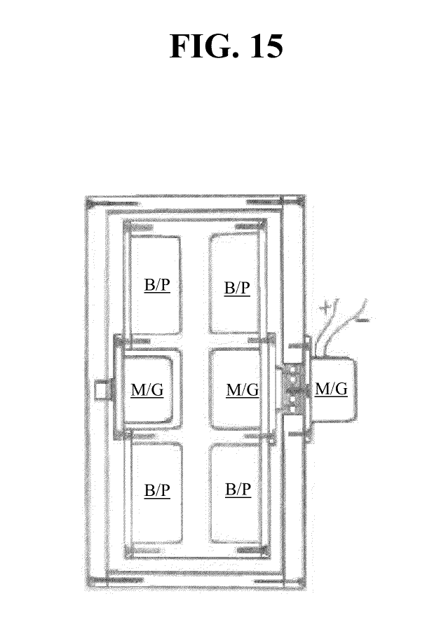

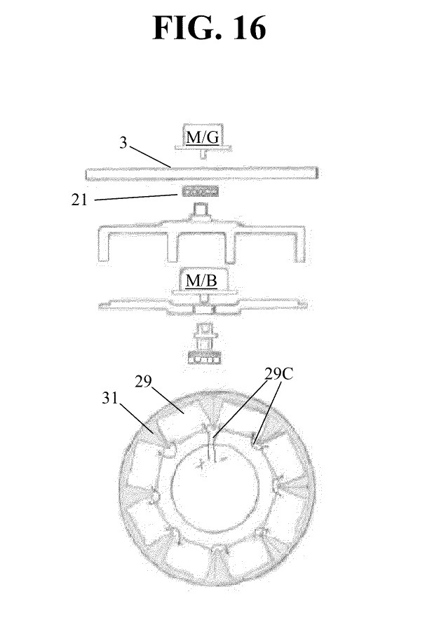

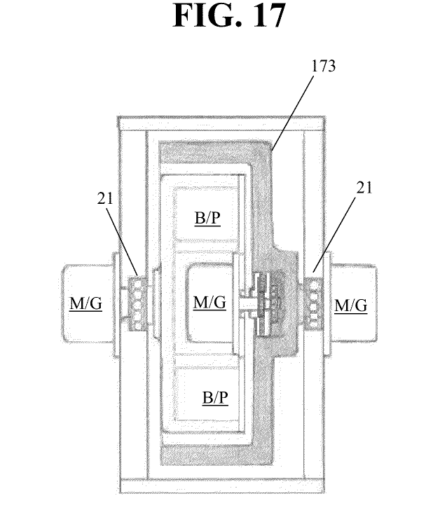

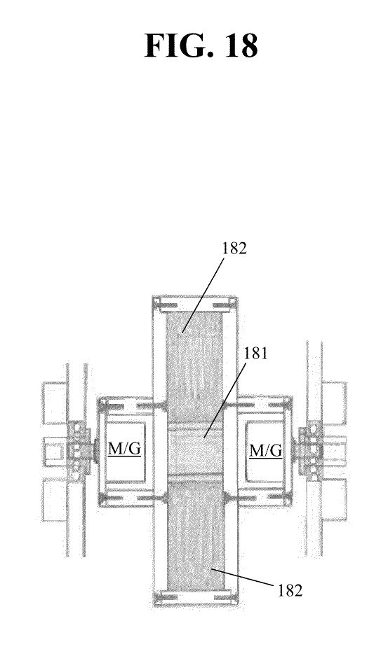

FIGS. 12 through 18 illustrate that charging and energy transfer can be accomplished without slip rings in various configurations of the hollow battery flywheel. B/P stands for battery pack. M/G stands for motor/generator. P/G C indicates planetary gearing being used to counter-rotate a mechanical flywheel or a self-contained battery flywheel that contains a low-friction clutch that can regulate the amount of force and rotational speed. FIG. 12 shows a hollow battery flywheel combination connected directly to a counter rotating disk flywheel 3. Counter-rotating mass should be equal by computational and mathematical design. FIG. 13 shows the same idea with a planetary gear and clutch P/G C that separates the mechanical from the contained system. This shows a direct connection of the flywheel and clutch P/G C to control the amount of force delivered. This system of clutching action can be used in all systems to use the spinning hollow battery as a kinetic way of gradually spinning up the mechanical flywheel 3 until it reaches a speed equal to the motion and applied force. FIG. 14 shows a connected self-contained counter rotating flywheel combination in a single case. FIG. 15 shows the hollow flywheel with solid center core and the motor/generators M/G on each side with contained battery flywheel system. This flywheel is of unique design and should be cut from a solid billet of steel or adequately strong material, or cast as a solid mass. FIG. 16 is a breakdown of the components of the hollow flywheel battery combination showing the epoxy 31 filled outer hub and the battery 29 connection 29C. Note that the flywheel and battery motor M/B turn together as a unit, directly powering a motor/generator M/G on the other side. FIG. 17 shows the hollow flywheel battery B/P combination rotating inside of a mechanical flywheel enclosure 173 that is counter rotating by use of an internal 1:1 planetary gearbox. The battery B/P design rotating inside of a mechanical flywheel 173 is all housed in an enclosure thereby improving safety. FIG. 18 rotating enclosed battery combination with two motors. The center of the spinning mass 181 contains the electronics, while the darkly shaded area 182 houses the batteries.

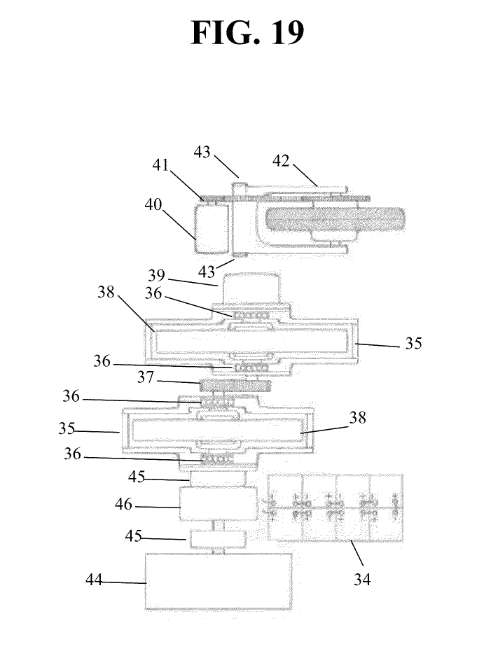

FIG. 19 illustrates a hybrid drive system for DC to AC conversion using multiple counter-rotating flywheels 38, a DC battery pack 34 indicating 96 volts and a entire flywheel assembly with case 35 with low friction rotor bearings 36, interconnecting gears 37 of any type or configuration so that the flywheels can counter-rotate: a flywheel 38, AC motor/generator 39, AC drive motor 40, chain drive 41, belt drive or any means of power transfer including internal hub drive including swing-arm 42 which can be used on any two-wheeled or three-wheeled vehicle or any means of holding drive unit, tapered bearings 43 or any pivot point for swing-arm 42, any internal or external combustion engine 44 or any other power source sprag clutches 45, DC motor/generator 46.

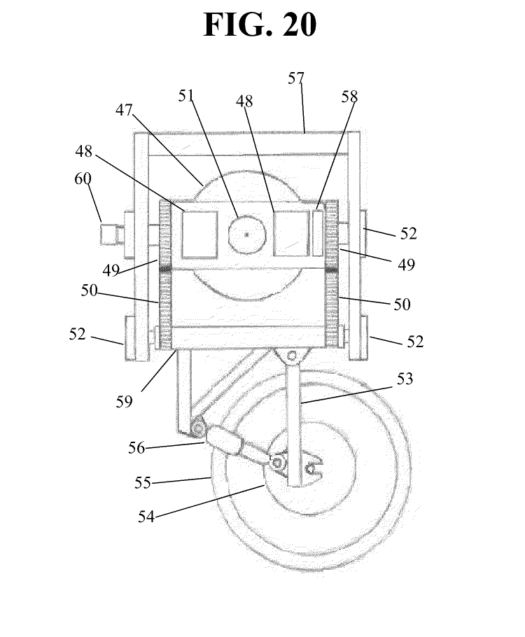

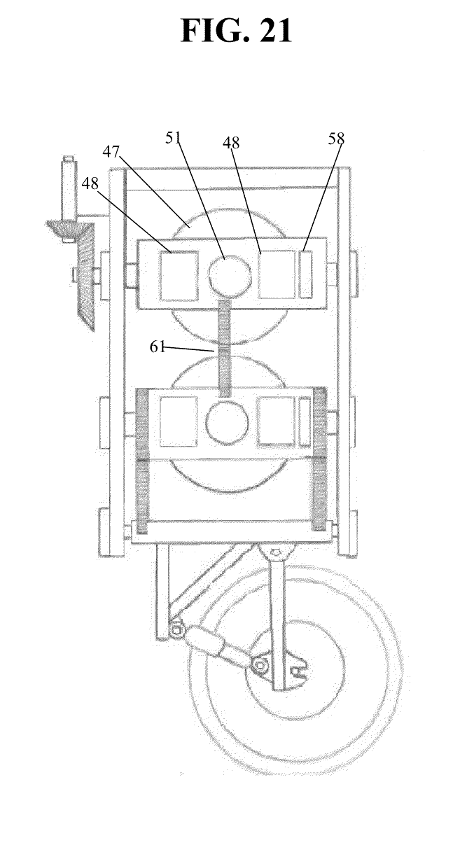

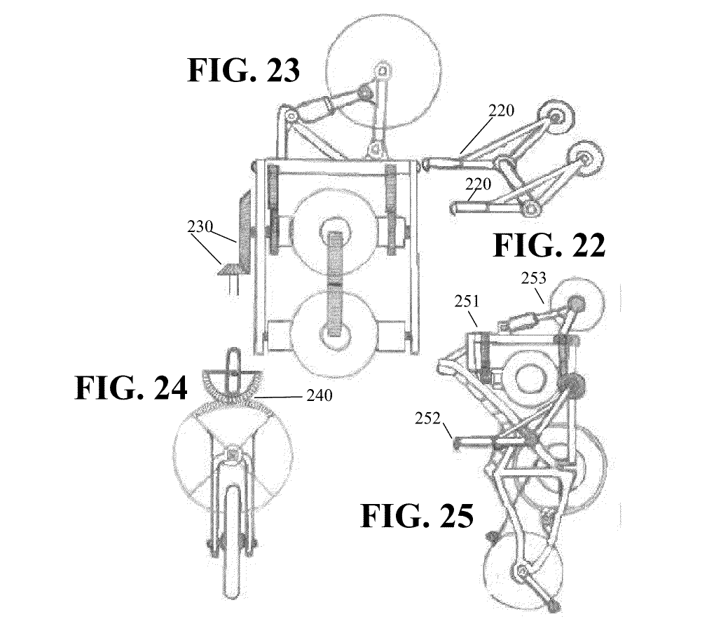

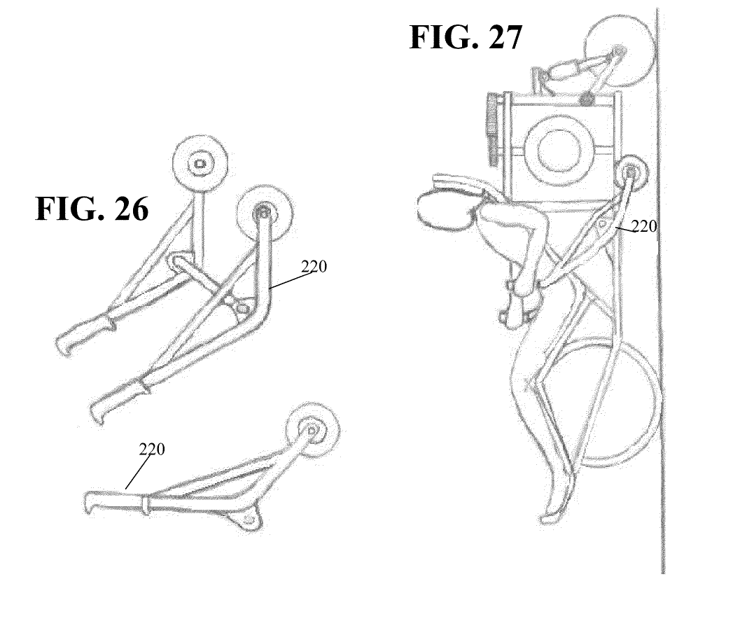

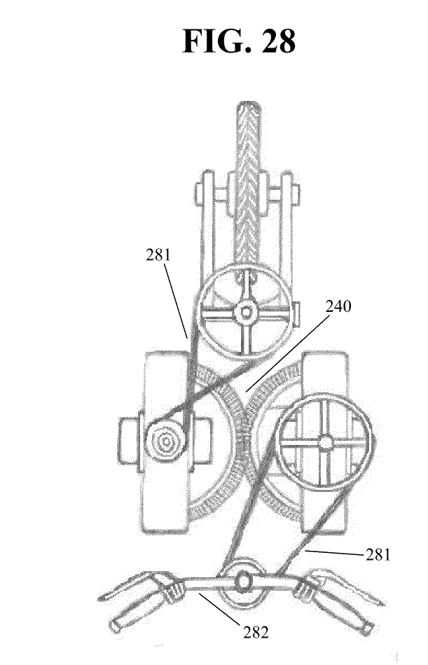

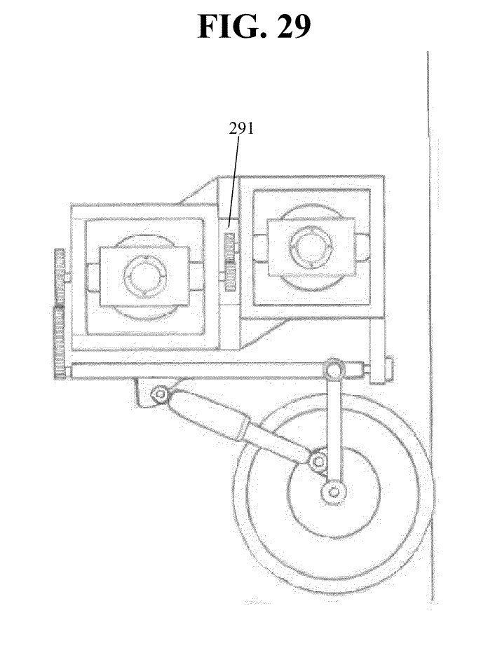

FIGS. 20 through 29 pertain to manually controlled and power assisted manual gyroscopic control systems whereby manual means are utilized to position the gyroscope and thus affect steering. FIG. 20 illustrates a manually controlled gyro system using top and bottom sectored gear to connect a swing arm to a vertically positioned gyroscope. When multiple gyroscopes are used, they can be positioned side-by-side, tandem in-line, staggered, or they may be stacked on top of each other. Referring to FIG. 20, there one can see a gyroscope 47 power source 48, and a gear 49 attached to the top and bottom of the gyroscope, a sectored gear 50 with a ratio of 2-to-1; the ratio can range changed. Linkages can also use beveled gears, cables, bell cranks, or any other means of manually connecting the gyroscope(s) to the steered wheel(s). Hydraulic and electronic means may also be used to link the gyroscope(s) and steered wheel(s) together so that they move in unison. The gyroscopes may also affect the bank attitude of the vehicle without being linked to the steered wheel(s) and swing arm(s). Gyro drive motor 51 can be electric, hydraulic or any power source including manual. Bearing holders 52 and sleeves, swing arm 53, and an electrically driven front or rear wheel hub 54 which may be driven by any type of power source. This can also be manually or hydraulically driven. in accordance with a steered wheel 55, shock absorbers 56, support frame 57 Motor controller 58, swing arm 59 access. Attachment 60 is shown for any manual and/or power assisted steering mechanism such as steering wheel or handle bar steering systems with hydraulic power steering. FIG. 21 shows an in-line, manually controlled double gyro system linked by sectored gears, with the center sectored gears 61. Multiple gyroscopes are counter rotating and linked by the center sectored gear 61. They can also be linked on the top and bottom to sectored gears. In addition to direct connection to the steering wheel or handle bar steering mechanism, other manual means may be utilized to position the gyroscope and thus affect steering. These manual means can include shifting body mass or any manually shifted weight that is attached to a manual or power assisted steering device or assists a manual or powered steering device. Moreover, manual means can also entail controlling the gyroscope(s) by contacting the ground with hands, feet or by use of the torquing arms. FIG. 22 shows torquing arms 220 to be attached to both sides of a gyro enhanced and gyro steered vehicle. These torquing arms 220 can be used to position the gyroscope while in a banking turn by exerting a force in the direction of precession by quickly making contact with the ground. They can also be used as a two positioned kickstand support and locked into position when the gyro is not in use. FIG. 23 in-line dual gyro steering, with direct gearing 230 to connect the linked gyroscopes to the steering apparatus and steered wheel. FIG. 24 top view of direct gearing 240. FIG. 25 gyro steered 251 and manually torqued 252 rear wheel 253 steered recumbent. FIG. 26 expanded view of the side torque arms 220 which also function as landing gears. FIG. 27 gyro steered recumbent using shifting body mass and torquing arms 220 to steer vehicle. FIG. 28 Dual side-by-side sector geared 240 gyro system using belt or chain drive 281 gear reduction with direct connection to handlebar 282 steering. A steering wheel can also be utilized. The gyroscopic system can also be linked to the steering apparatus by use of sectored gears, beveled gears, or bell cranks. Electronic and hydraulic means may also be used. Power steering may also be used in the system to lessen friction. FIG. 29 Stacked gear 291 connected dual gyro steered system

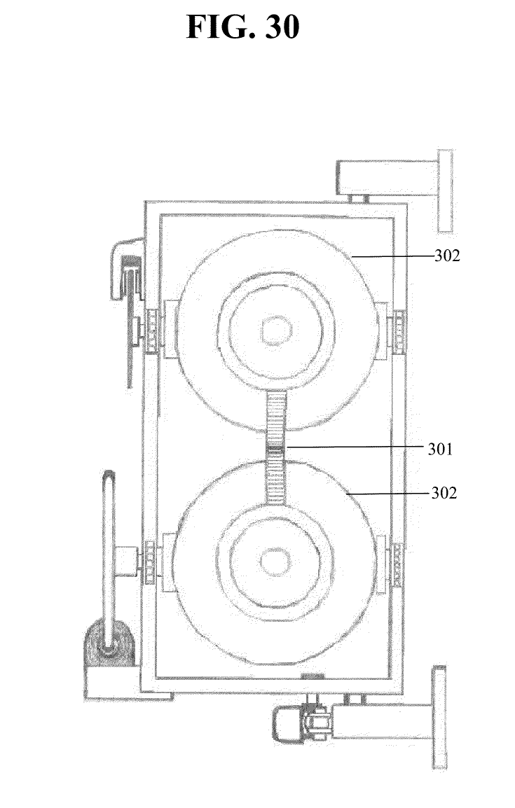

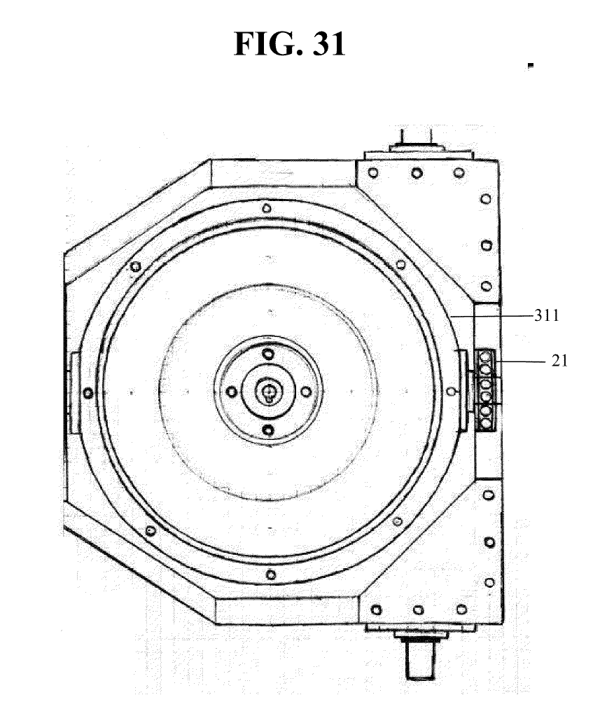

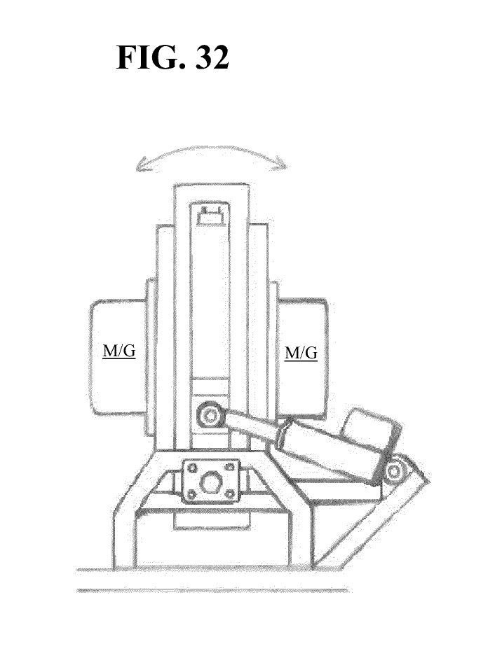

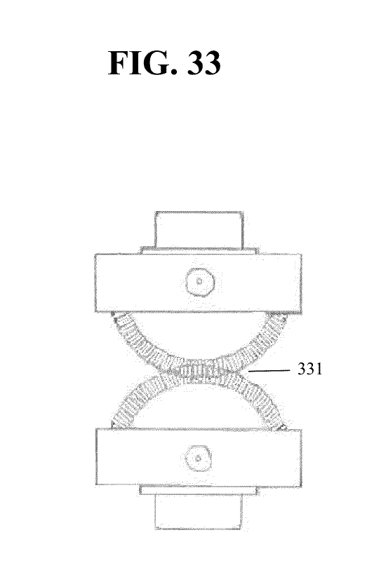

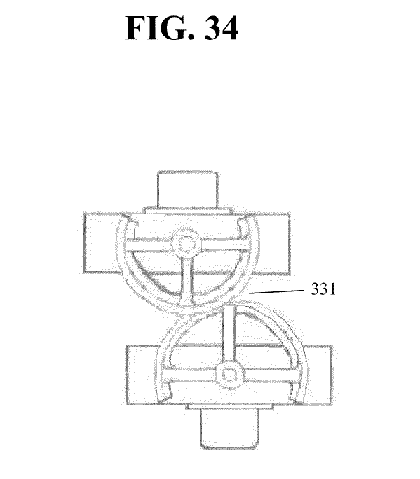

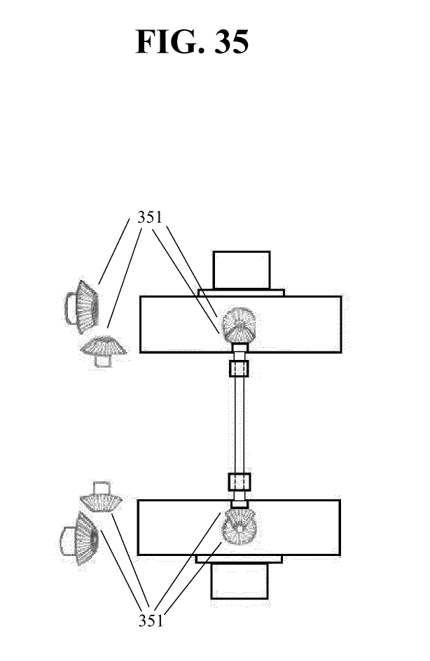

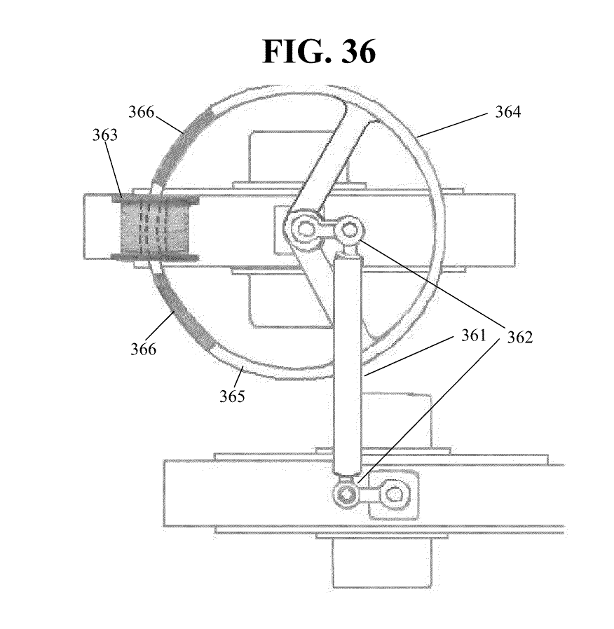

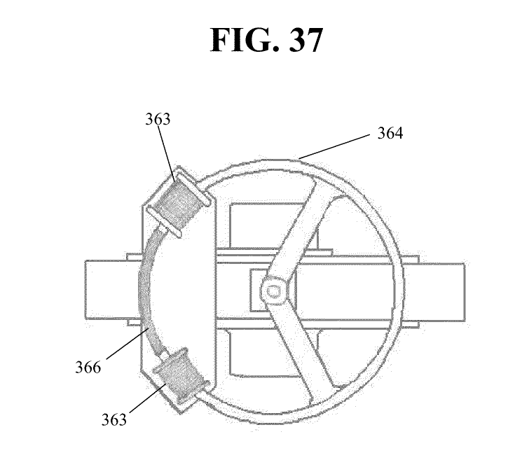

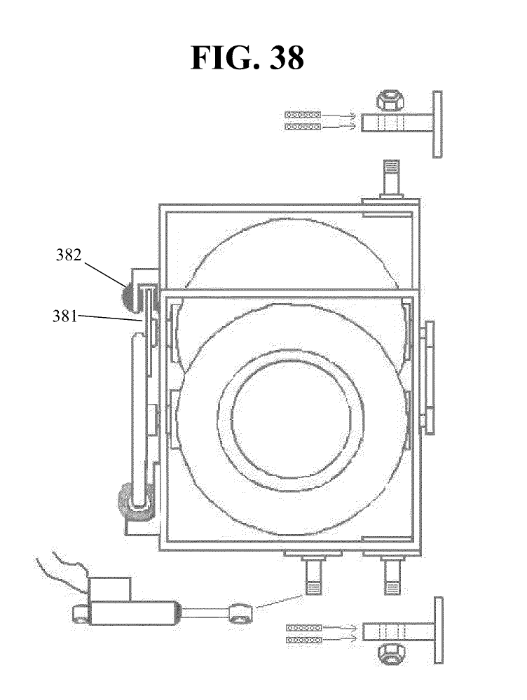

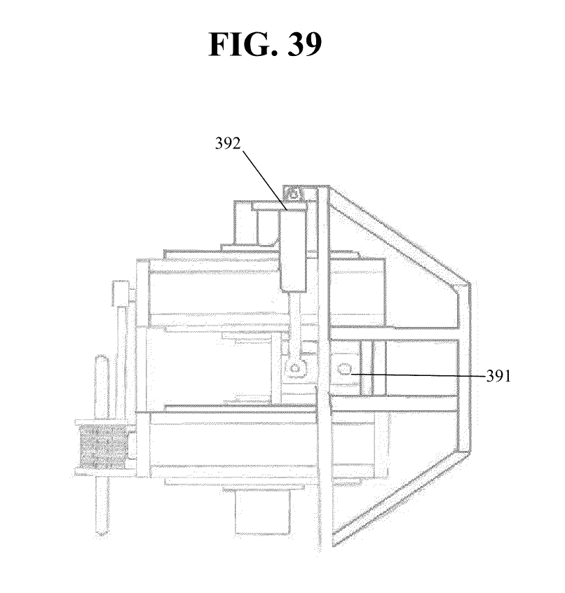

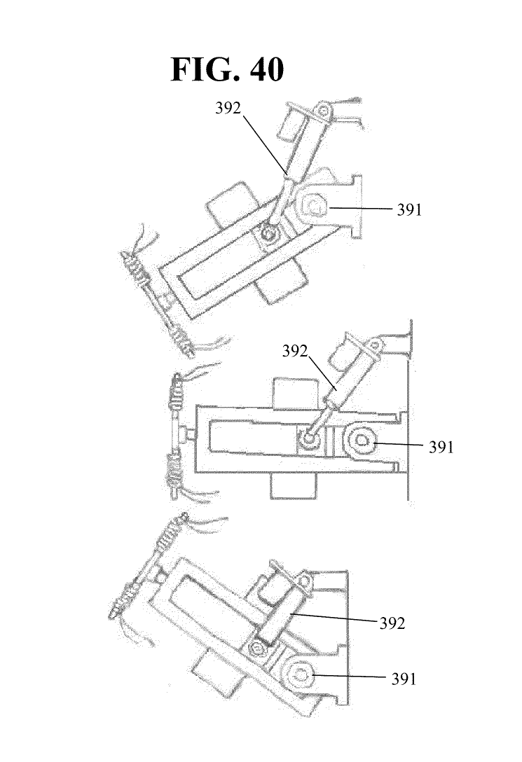

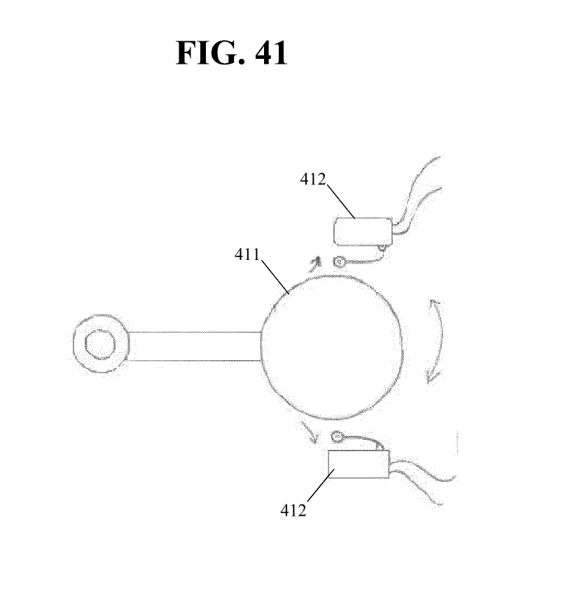

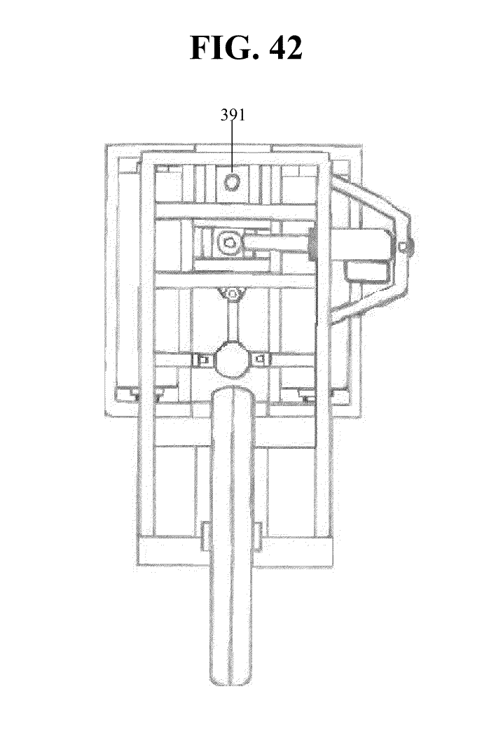

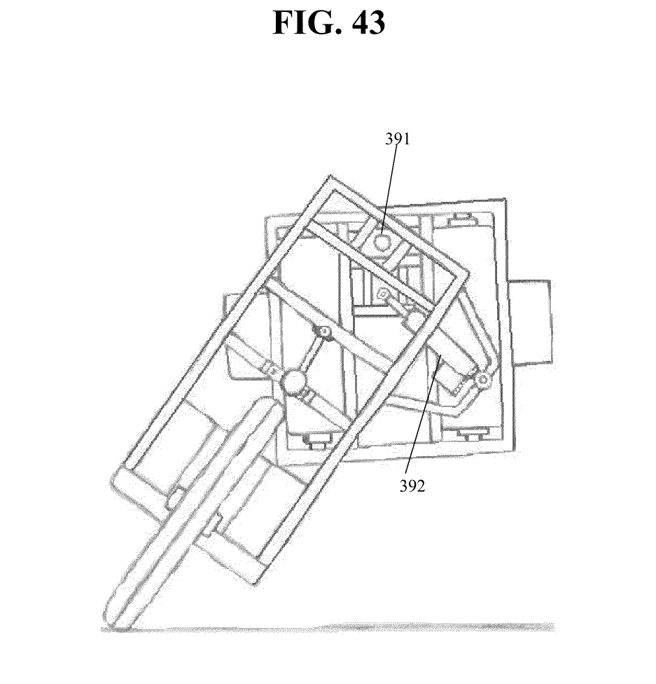

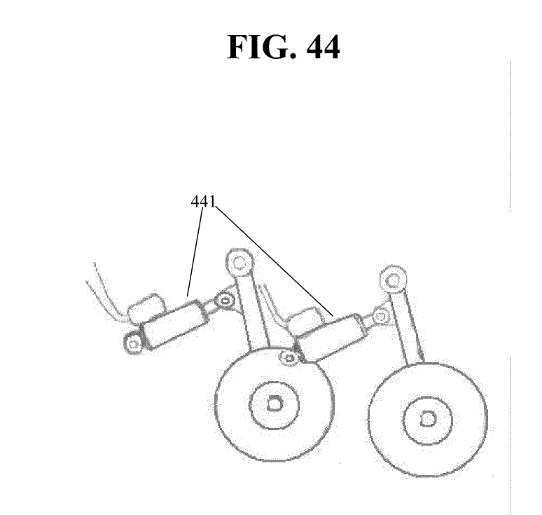

FIGS. 30 through 44 depict aspects of automatic stabilizing gyroscopic and kinetic energy recovery systems. FIG. 30 Illustrates automatic in-line two gyro control system using center mounted sectored gears 301. The two gyroscopes 302 are spinning in opposite directions. FIG. 31 illustrates a single gyroscope 311 which may also be used in an automatic system. FIG. 32 A motor/generator M/G is connected on one or both sides of the gyroscope and used in conjunction with blocking diodes or commonly known switching systems to convert kinetic energy into electrical energy and transfer it to and from the electric drive wheel. FIG. 33 two counter-rotating gyroscopes can be linked side-by-side using sectored gears 331. FIG. 34 they can also be linked in a staggered configuration using sectored gears 331. FIG. 35 beveled gears 351 may also be used to link the counter-rotating gyroscopes. FIG. 36 Staggered gyroscopes linked by using a bell crank 361 and low friction bearings 362. Gyroscopic precession can be controlled by use of an induction coil 363 and a torquing ring 364 or wheel affixed to a primary gimbal. This ring is composed of nonmetallic materials 365 except for two magnetic or metallic sections 366 that pass through the induction coil 363. As the gyroscope(s) precess, the movement activates a rheostat switch or similar device that increases the voltage to the coil and torques the ring. FIG. 37 illustrates that alternatively, two induction coils 363 can be used, with one magnetic or metallic section 366 on the torquing ring 364 to control precession. FIG. 38 Gyroscopic precession can be caged by using a disk brake 381 in conjunction with a manual or hydraulic brake caliper 382 located on either the top or bottom axis of a primary gimbal. FIG. 39 Gyroscopic drift can be controlled by using a secondary gimbal 391 offset below center, and a linear motor 392 or similar device. FIG. 41 the linear motor 392 is activated by a weighted swinging pendulum 411 device that contacts a micro switch 412 on either side. A tilt sensor such as a mercury switch can also be utilized. Accelerometers and microcontrollers can also be used to activate the drift control system. FIG. 42 the secondary gimbal 391 can also be offset above center. FIG. 43 illustrates the drift control system activated in turns. FIG. 44 landing gears on each side of the trailer can be lowered and locked into place automatically using linear slide motors 441 or similar devices, activated by tilt sensors such as mercury switches or a swinging pendulum 411 device with micro switches 412. Accelerometers and motors controlled by microcontrollers can also be used to activate the landing gear system. Manual means of deploying the landing gears using linear slide motors of similar devices can be used alone or in conjunction with an automatic system.

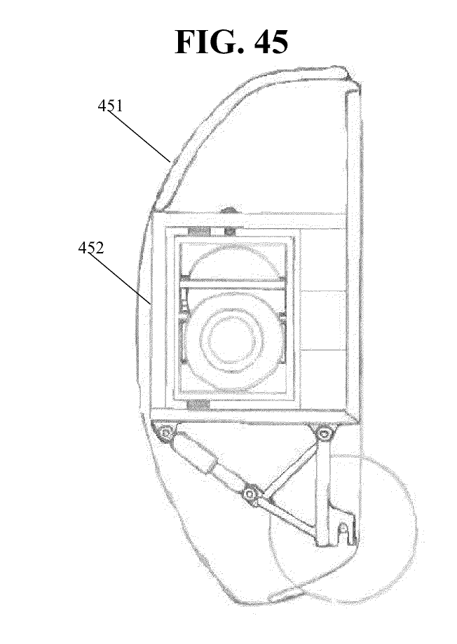

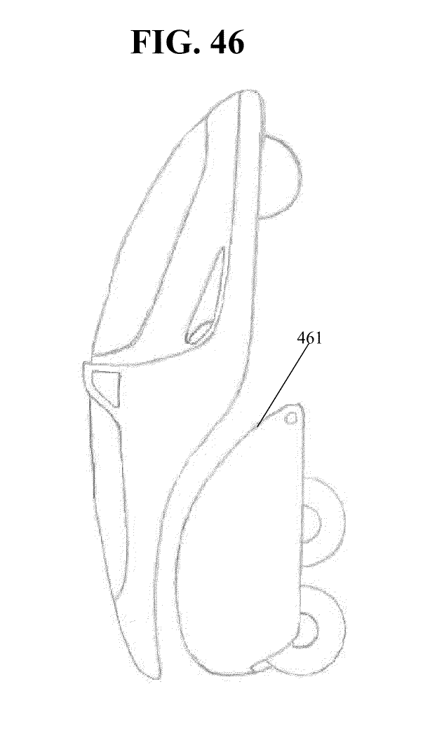

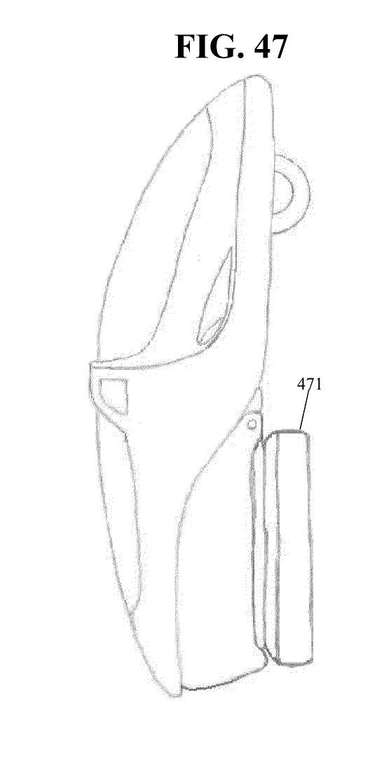

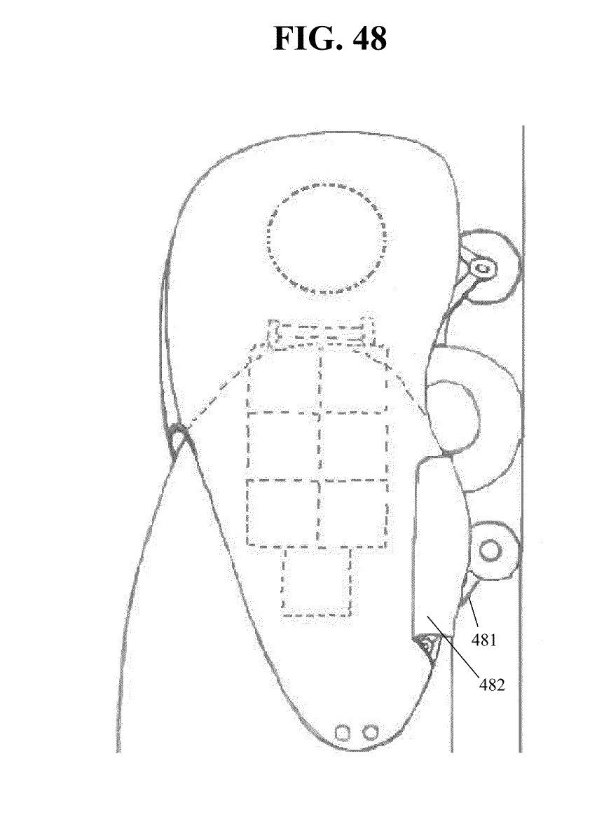

FIGS. 45 to 48 illustrate aspects of self-contained gyroscopic modules. It can function as a gyro-trailer 451 which can be configured in a variety of ways to stabilize vehicles. FIG. 45 illustrates that two counter-rotating gyroscopes 452 can be staggered to reduce the width of the trailer. FIG. 46 an in-line two wheeled hybrid gyro trailer 461 would allow the use of two power sources, with both wheels functioning together or separately. FIG. 47 a hover pad 471 can replace the trailer wheel for even less road friction and an air cushion ride. FIG. 48 landing gear 481 can be deployed and hidden behind trapped doors 482. Trailer module with trailing weight support wheel can be used with landing gear deployed.

How the Invention Works:

FIGS. 1 through 4 illustrate stronger designs for high-speed flywheels 5, 6 which can be used in our gyroscopic systems. They have no hole through the center, but have staggered mounting holes that do not penetrate the flywheel, and use bolt-on hubs. Bolts that do penetrate the flywheel all the way through could be used but they should not go through the center of the flywheel.

FIG. 5 shows a multi-disk flywheel bolted together with a staggered bolting pattern so that bolt holes don't line up. There is no hole in the center. Disks can be computer laser cut and drilled using the same process. This is a low cost, simple bolt together assembly. It is expandable by changing the length of bolts and adding more disks.

FIGS. 6 through 11 self-contained flywheels with the batteries, electronics and motors in vacuumed or partially vacuumed cases, using slip rings to transfer energy from the rotating mass. By containing all of these elements in one rotating mass, all electrical contact to batteries and motor generators can be kept to a minimum length in order to keep heat loss from direct current as low as possible. Many battery chemistries would benefit from the centrifugal force that occurs in a spinning battery. This embodiment enables a practical solution for current metal air batteries of any kind that are well known in the field. For certain battery chemistries such as zinc, nickel cadmium and some lithium ion batteries, centrifugal force will inhibit dendrite growth which can cause shorting in batteries and limits the charging cycle. Centrifugal force also could be used to circulate and redistribute chemicals that are present in vanadium or other flow batteries without the use of pumps. Furthermore, centrifugal force could be used to evacuate and drain caustic acids or fluids from the flywheel when not in use, resulting in a longer battery life. Moreover, the spinning action of the flywheel will facilitate circulation and heat dissipation throughout the battery system.

FIGS. 12 through 18 illustrate that charging and energy transfer can be accomplished without slip rings in various configurations of the hollow battery flywheel. All embodiments can incorporate the use of a remote control internal starting and charging switch with a device like an internal blocking diode to facilitate switching between motor and generator functions on demand. By the use of a device like an internal blocking diode, multiple counter-rotating flywheels can be used as a transmission to double or even triple the amount of energy that can be transferred to the drive motor for acceleration, or taken from the drive motor for stopping and transferred to flywheel(s). When decelerating, kinetic energy that is normally lost as heat with friction braking is being transferred to the flywheel for later use. Energy is transferred electronically by applying hand or foot pressure to a lever or peddle to vary the amount of kinetic energy being stored in the flywheel(s) or utilized for forward motion.

FIG. 19 illustrates a hybrid drive system for DC to AC conversion using multiple counter-rotating flywheels of high-speed design. This illustration shows an economical way to convert DC to AC but the invention is applicable to convert any number of systems. A hybrid system combining an internal combustion or external combustion engine in a parallel or series connection, or a combination of both, driving a DC motor/generator that is connected to one side of the flywheel energy return system while the other side is connected to an AC motor/generator, hydraulic pump or any other form of motor/generator combination that is known in the field (e.g. an air compressor to keep an air tank at a constant pressure that in turn would run an air motor that can assist the drive motor or indeed power the vehicle or drive system on its own). The kinetic conversion system can eliminate the need for a costly DC to AC converter that is commonly used in electric vehicles such as the well known EV1 briefly manufactured by General Motors.

For both manually controlled gyroscopic systems, and automatic stabilizing gyroscopic systems, one or more gyroscopes oriented vertically with a horizontal axle should be spun at a sufficient rate to provide adequate angular momentum to stabilize the vehicle. If more than one gyroscope is employed, they should be paired and counter-rotated to offset any rotational bias. Multiple gyroscopes should be linked so that they move in unison on the primary gimbals. Linkages should minimize friction. Center sectored gears are an effective way of linking the gyroscopes. Alternatively, the sectored gears can be placed near the top and bottom of the primary gimbals. The gyroscopes can be configured side-by-side, in-line tandem, staggered or stacked on top of each other, depending on factors such as space requirement. Beveled gears, pulleys with chains or cables, or a bell crank system with low friction bearings can also be used to link gyroscopes on the primary gimbals. Multiple gyroscopes can also be linked electronically or via hydraulics so that they move in unison. The gyroscope(s) also function as kinetic energy return flywheels to return braking energy back to the system for later use in acceleration either electronically or mechanically. When electronically transferred, the motors are engaged to spin up the flywheels, while generators are engaged when energy is taken from the flywheels and transferred to the drive motor for use in acceleration.

FIGS. 20 to 29 illustrate manually controlled gyroscopic systems, in which the driver controls the vertically positioned gyroscope(s) by manual means. A steering mechanism such as a steering wheel or handle bars can be linked to the gyroscopic system using direct gearing, pulleys with cables, or belts, sprockets with chains, bell cranks, control arms, or similar method. The precession of the gyroscope(s) can also be controlled by other manual mean such as shifting of body mass or any manually shifted weight, or by use of torquing arms. To reduce friction in the system the steering mechanism may be assisted by a hydraulic or electronic power steering unit, or similar device. By linking the steering to the gyroscope(s) we have a simple means of torquing the gyroscope(s) and controlling them when stationary, in motion and during turns and cornering. The bank attitude is established in space by a basic roll reference sensitive to dynamic vertical and turns are initiated by biasing said space reference from dynamic vertical.

FIG. 30 through 48 illustrate automatic gyroscopic systems. The low friction gyroscopic stabilizing system incorporates the precession control system and the drift control system, and can include the gyro caging system and drift control landing gears. The system as a whole serves to provide stability while stationary and in motion. Friction should be minimized in the entire gyro system. The precession control system is comprised of a torquing wheel on a primary gimbal, induction coil(s), and a rheostat switch. The induction coils do not come into contact with the torquing wheel, providing a frictionless means of controlling precession. As the gyroscope(s) precess, the movement activates the rheostat switch which increases the voltage to the coil(s) and torques the wheel in the direction of precession. The gyroscope(s) react with a force to bring the system into balance. Alternative torquing systems using servo motors or similar devices may be employed on a primary gimbal to control precession. Hydraulic and electronic systems may also be used to control precession in a similar way. The gyroscopic drift control system shifts the mass of the gyroscope assembly on the secondary gimbal, which in turn exerts a force on the gyroscope in the primary gimbal. The pivot point on the secondary gimbal can be offset either above or below the center of the gyroscope unit. The distance from center to the pivot point can be varied to vary the amount of mass being shifted. The pivot point can also be in the center of the secondary gimbal but less mass will be shifted. The drift control system can be activated by a swinging pendulum device that contacts micro switches on either of its sides. Alternatively a tilt sensor device such as a mercury switch may be used. Accelerometers with microprocessors may also be used. Once activated, a device such as a linear gear motor or torquing motor is utilized to shift the mass on the secondary gimbal, which in turn exerts a force on the gyroscope in the primary gimbal. The secondary gimbal can also be linked to the steering system via a gearbox to provide a manual means of controlling drift. The drift control system on the secondary gimbal can function independently from the precession control system on the primary gimbal, and can even be used with nothing controlling primary gimbal. The gyro caging system is comprised of a manual or hydraulic brake caliper and a disk brake on the top or bottom of a primary gimbal. It is a simple and inexpensive way of freezing the precession of the gyro while under power and releasing it when the gyro system has reached desired stabilizing speed of rotation. The landing gear system can be automatically and/or manually lowered and locked into place using linear slide motors or rotational gear motors of a high gear ratio to support the trailer module and vehicle when the gyroscope(s) are not in operational mode or have not attained adequate angular momentum to support the vehicle. Moreover, the landing gears may be activated on either side of the vehicle to provide another means of centering the gyroscopes and manually correcting drift by making contact with the ground and thereby applying a force. The landing wheels can also be made to correct drift automatically using a pendulum or center sensing switch as used in the secondary gimbal system, and can be overridden and activated with a manual control switch.

FIG. 45-48 illustrate self contained gyroscopic trailer modules. A wrap around trailer may be attached to any one or multi wheeled vehicle with reinforced and supported contact points designed to transfer the twisting torque of the gyroscopic stabilizing system to the center of the vehicle. The trailer module is self-contained and powered by electric, or a combination of electric and fuel engine for greater range. An in-line two wheeled hybrid gyro trailer would allow the use of two power sources, with both wheels functioning together or separately. Alternatively two or more power sources could power a common drive shaft.

The flywheel disks can be constructed of steel, carbon fiber, or any high strength material or combinations of high strength materials, and laser cut for high precision and balance. Epoxy resin and metal powders could also be used or any combination thereof. Off the shelf controllers and switching systems can be incorporated in the design or any combination thereof. By building a remote control switch within the flywheel itself, flywheel systems could be started and brought up to speed prior to use. Remote control would also enable switching between charging and power transfer from a distance with no direct switch required. The flywheels could be made to function in a completely mechanical way by the use of sprag clutches, belts, passive magnetic clutching, and low friction clutching methods. A light helium or hydrogen atmosphere after vacuuming the air from the flywheel housing will improve the efficiency of the system overall. A Teflon or low friction coating on the flywheel or on any rotating surface will improve efficiency. Teflon bearings will also lesson friction. Mass production could lower the cost. Any even number of flywheels and motor/generators that are counter-rotated could be used. Placement can be varied from side by side, in-line or staggered, in vertical or horizontal placement. The larger the diameter and the greater the mass the more kinetic energy may be utilized. A larger flywheel moving at the same speed as a smaller one will be able to store much more rotational energy. Because centrifugal force and centripetal force in any spinning mass converge in the center, a rotating mass with a hole through the center mass is weakened significantly. With a large diameter flywheel with no hole in the middle, a stronger, cheaper and more practical method of storing the kinetic energy is achieved. Although the flywheels in these inventions will work at higher speeds, by spinning the flywheel(s) at relatively slow speeds, stress on the bearings is significantly reduced as are problems associated with materials stress and high speed vibrations. Depending on the diameter, rim speed should not exceed the speed of sound. One way of constructing a flywheel with a hole through the center is to incorporate electron beam welding to bond a machined inner axle with a flat disk with a hole through the center. The materials will bond into a single mass as if it were machined from a solid billet. Another method is to have the axle hole in the center supported by outer plates composed of aircraft aluminum or other material of adequate strength and further supported by an inner and outer case ring made of adequate strength.

For manual and automatic gyroscopic systems, the gyroscope(s) should be vertically mounted and spun around a horizontal axis using low friction bearings. Friction should be minimized in the entire gyro system. When more than one gyroscope is used for stability, they should be paired, counter-rotated, and linked using sectored gears, beveled gears, a bell crank, or pulleys. They can also be linked using electronic or hydraulic means, or any other low friction means so that they move in unison around their primary gimbals. The gyroscopes can be placed side-by-side, in-line tandem, staggered, or stacked on top of each other. All gimbals should utilize low friction or magnetic bearings. The gyroscopes can be encased and kept in a vacuum or partial vacuum to further reduce friction.

For the manually controlled gyroscopic systems, by linking the gyroscope(s) to the steering apparatus, a simple means of torquing the gyroscope and controlling it in cornering and banking turns. The steering apparatus can utilize a steering wheel, handle bars, joysticks or any other method of steering a vehicle. This system is a manual one but hydraulic or electronic linkages that are controlled by a manual means may also be utilized as in a power steering unit that is hydraulically or electronically powered by so that an assisting force can be applied. Alternatively, the gyroscope(s) may also be torqued by using controls that are separate from the steering apparatus. A separate button or lever can be placed on the steering wheel, handlebar or joystick to control the torquing of the gyroscope(s). Foot peddles may be used to torque the gyroscope(s). Single or multiple gyroscopes will precess with any applied force. By using a manually linked gearing system a force can be applied to control bank and lean. Besides direct connection to the steering apparatus, other manual means may be utilized to position the gyroscope and thus affect steering. These manual means can include shifting body mass or any manually shifted weight that is attached to a manual or power assisted steering device or assists a manual or powered steering device. Moreover, manual means can also entail controlling the gyroscope(s) by contacting the ground with hands, feet or by use of the torquing arms. The gyroscope(s) may be linked the front and/or rear steered wheel(s) and the swing arm(s) by use of sectored gears, beveled gears, pulleys with cables and belts, sprockets with chains, bell cranks, or any number of mechanical methods. They may also be linked using hydraulic or electronic methods. Furthermore, the gyroscopes may also affect the bank attitude of the vehicle without being directly linked to the steered wheel(s) and swing arm(s). Thus the system can also be used on vehicles without wheels such as hovercraft, aircraft and watercraft. It can also be used on stationary platforms where banking is desired.

For the automatic gyroscopic systems, the precession control system should utilize a low friction method of increasing the torque applied to the primary gimbals as the precession increases. A torquing wheel in combination with induction coil(s) and rheostat(s) would be such a system, adding no additional friction to the primary gimbal. Alternatively, servo motors or similar devices can be used to apply a force in the direction of precession on the primary gimbal. The drift control system shifts the mass of the gyro system in the secondary gimbal, thereby exerting a force on the gyroscope in the primary gimbal. It can be used in conjunction with any precession control system on the primary gimbal. The drift control system on the secondary gimbal can also be made to function without any control system on the primary gimbal. The pivot point on the secondary gimbal can be offset either above or below the center of the gyroscope unit. The distance from center to the pivot point can be varied to vary the amount of mass being shifted. The pivot point can also be in the center of the secondary gimbal but less mass will be shifted. The drift control system can be activated by a swinging pendulum device that contacts micro switches on either side. Alternatively a tilt sensor device such as a mercury switch can be used. Accelerometers and microprocessors may also be used to sense tilt. Once activated, a device such as a linear gear motor or torquing motor is utilized to shift the mass on the secondary gimbal, which in turn exerts a force on the gyroscope in the primary gimbal. The secondary gimbal can also be linked to the steering system via a high gear ratio gearbox to provide a manual means of controlling drift. The gyro caging system is comprised of a manual or hydraulic brake caliper and a disk brake on the top or bottom of a primary gimbal to freeze precession. Pairs of affixed counter-rotating flywheels without the use of gimbals could be used in trailers for kinetic energy recovery and acceleration without gyro-stabilization. The caged flywheels may be either horizontally or vertically mounted if not used for gyroscopic effects.

The automatic gyroscopic system can be placed in the detachable module along with batteries, electric or hybrid drive units, and electric components that make it a self contained unit. The module can also be used without powered wheels as a self-contained stabilizer. When used as a powered trailer, it can utilize a single wheel, or a pair of in-line wheels for hybrid systems with more than one power source. Hybrid systems utilizing two or more power sources could alternatively power a common drive shaft. An in-line support wheel may also be utilized. By keeping wheels in-line, maneuverability and handling are not hindered as with side support wheels. However, trailers with wheels on each side can also be constructed to benefit from the self contained gyroscopic control system with kinetic energy recovery and acceleration. The arms connecting the vehicle to the trailer are important to transfer the torque of the gyro system forward, backward or to the center of the vehicle at the point of connection. The point of connection can be reinforced to work as a roll cage in construction of the vehicle. The landing gear system can be automatically or manually lowered and locked into place using linear slide motors to support the trailer module and vehicle when the gyroscope(s) are not in operation mode or have not attained adequate angular momentum to support the vehicle. Moreover, the landing gears may be activated on either side of the vehicle to provide another means of centering the gyroscopes and manually correcting drift. The landing wheels can also be made to correct drift automatically using a pendulum or center sensing switch as used in the secondary gimbal system, and can be overridden and activated with a manual control switch.

One or more gyro/flywheels may be used to create the same desired effect with varying results in practical application. Two or more counter-rotating gyro/flywheels are recommended for vehicles that are used on public roads. A hover system which incorporates fans and hover pads could be substituted for trailer wheels for reduced road friction. The module can be used as a self-contained stabilizer without the attached powered wheels. Pairs of affixed counter-rotating flywheels without the use of gimbals could be used in vehicles and trailers with side-by-side or in-line wheels for kinetic energy recovery and acceleration without gyro-stabilization. The caged flywheels may be either horizontally or vertically mounted if not used for gyroscopic effects.

How to Use the Invention:

This invention provides a means to make a stronger, cheaper and more effective way of recovering kinetic energy lost when braking and reusing that energy for acceleration. It could be used in any form of transportation or off road recreational vehicle where energy is wasted by braking or compression systems, as in a changing of gears or use of a clutch. Basically this invention will act as a self-contained mechanical battery or capacitor to store and release large amounts of kinetic energy on demand.

This invention could be used in any stationary setting where the wind, moving water or ocean waves could be utilized as a kinetic power source. Although the use of multiple counter-rotating flywheels would eliminate vibrations and nutation problems, in stationary applications a single flywheel could be used. If multiple flywheels are utilized, they should be counter-rotated to counteract gyroscopic forces unless these gyroscopic forces can be used constructively for stability. Any of these flywheels will become gyroscopes if they are placed in gimbals and are free to precess, and can provide stability in gyroscopic systems.

This invention will provide a simple means of controlling precession and correcting drift either by the use of a manually controlled gyroscopic system, or an automatic stabilizing gyroscopic system. The systems can be used in transportation vehicles including off-road vehicles, watercraft, hovercraft, light aircraft, snow craft, gyrocopters and helicopters.

The manually controlled or power assisted manually controlled gyroscopic system can be used to provide stability to vehicles, while at the same time allowing the driver to maintain control of the bank attitude of the vehicle during turns. It is also applicable to any situation where a manually controlled stable platform is desirable. It is a simple, inexpensive and practical way to manually control precession and correct drift in a gyroscope while being able to store and release kinetic energy when using our flywheel energy return system as a gyroscope. This invention could be used on anything that would benefit from gyroscopic forces that are manually controlled or that require increased stability. One example would be gyroscopic flight simulators. Another would be exercise equipment or exercise related devices and machines that would affect core exercise motion.

The automatic gyroscopic system can be used to self-stabilize vehicles. When placed in a trailer unit, the gyro power trailer could be attached to any single or multiple wheeled vehicles to create a stable fuel-efficient mode of transportation. The reinforced attachment section transfers the twisting torque of the contained gyro or linked counter rotating gyroscopes. Batteries, gyroscope(s), motors, engines and generators would all be placed in the trailer section, thus leaving the main vehicle free from the issues of storing such items in the main cabin, and freeing up more space for passengers and storage. The module can be used without powered wheels as a self-contained stabilizer.

The efficiency of the design and operation of a kinetic energy recovery system facilitated by a gyroscopically mounted flywheel system programmed to optimize mechanical stability over velocity and turning profiles and to most continuously and expeditiously respond to steering conditions remains the highest concept to which the present invention claims novel priority.

From the preceding description of the present invention, this specification manifests various techniques for use in implementing the concepts of the present invention without departing from its scope. Furthermore, while this specification describes the present invention with specific reference to certain embodiments, a person of ordinary skill in the art would recognize that one could make changes in form and detail without departing from the scope and the spirit of the invention. This specification presented embodiments in all respects as illustrative and not restrictive. All parties must understand that this specification does not limit the present invention to the previously described particular embodiments, but asserts the present invention's capability of many rearrangements, modifications, omissions, and substitutions without departing from its scope.

Thus, Gyroscopic Systems to Stabilize Vehicles and recycle Kinetic Energy have been described.

What is claimed is:

1. A vehicle with a kinetic energy recovery system comprising:
a gyroscopic system;
a flywheel mounted in said gyroscopic system;
a means of controlling precession and correcting drift of said flywheel;
wherein said means of controlling precession and correcting drift comprises a manually controlled gyroscopic system, or comprises use of an automatic gyro-stabilizing system.

2. The vehicle with a kinetic energy recovery system of claim 1 wherein said flywheel comprises multiple disks bolted together in a staggered pattern.

3. The vehicle with a kinetic energy recovery system of claim 1 wherein said flywheel comprises a self-contained rotating battery.

4. The vehicle with a kinetic energy recovery system of claim 1 wherein said flywheel comprises a hybrid drive system for DC to AC conversion.

5. The vehicle with a kinetic energy recovery system of claim 1 wherein said flywheel comprises an electric gyro drive.

6. The vehicle with a kinetic energy recovery system of claim 1 wherein said flywheel comprises a hydraulic gyro drive.

7. The vehicle with a kinetic energy recovery system of claim 1 wherein said a means of controlling precession and correcting drift of said flywheel further comprises multiple gyroscopes counter rotating and linked by a center sectored gear.

8. The vehicle with a kinetic energy recovery system of claim 1 wherein said means of controlling precession and correcting drift of said flywheel includes manual means.

9. The vehicle with a kinetic energy recovery system of claim 1 wherein said means of controlling precession and correcting drift of said flywheel includes automatic means.

10. The vehicle with a kinetic energy recovery system of claim 8 wherein said manual means of controlling precession and correcting drift of said flywheel comprises shifting body mass or any manually shifted weight that is attached to a manual or power assisted steering device or assists a manual or powered steering device.

11. The vehicle with a kinetic energy recovery system of claim 8 wherein said manual means of controlling precession and correcting drift of said flywheel comprises torquing arms that can be used to position the gyroscope while in a banking turn by exerting a force in the direction of precession by quickly making contact with the ground.

12. The vehicle with a kinetic energy recovery system of claim 9 wherein said automatic means of controlling precession and correcting drift of said flywheel comprises caging gyroscopic precession can by using a disk brake in conjunction with a manual or hydraulic brake caliper

13. The vehicle with a kinetic energy recovery system of claim 9 wherein said automatic means of controlling precession and correcting drift of said flywheel comprises tilt sensor, accelerometers or micro-controllers that activate the drift control system.

14. The vehicle with a kinetic energy recovery system of claim 9 wherein said automatic means of controlling precession and correcting drift of said flywheel comprises a gyro-trailer which can be configured to stabilize vehicles.

15. The vehicle with a kinetic energy recovery system of claim 9 wherein said automatic means of controlling precession and correcting drift of said flywheel comprises a swinging pendulum device that contacts micro switches on either of its sides.

16. The vehicle with a kinetic energy recovery system of claim 9 wherein said automatic means of controlling precession and correcting drift of said flywheel comprises servo motors to apply a force in the direction of precession on a primary gimbal.

17. The vehicle with a kinetic energy recovery system of claim 16 wherein said servo motors to apply a force are activated by a swinging pendulum device that contacts micro switches on either of its sides.

18. The vehicle with a kinetic energy recovery system of claim 8 wherein said manual means of controlling precession and correcting drift of said flywheel comprises linking the gyroscope(s) to the steering apparatus.

19. A method of manually controlling precession in a gyroscopic mounted flywheel kinetic energy recovery system whereby the operator shifts body mass or any manually shifted weight that is attached to a manual or power assisted steering device.

20. A method of automatically controlling precession in a gyroscopic mounted flywheel kinetic energy recovery system whereby a torquing wheel on a primary gimbal, induction coil(s), and a rheostat switch provide a frictionless means of controlling precession.
